(19) United States
(12) Patent Application Publication
(10) Pub. No.: US 2011/0321145 A1
(43) Pub. Date: Dec. 29, 2011

(54) Method for Ensuring Security of Computers Connected to a Network

(76) Inventor: Susumu Shimotono, Hadano-shi (JP)

(21) Appl. No.: 13/116,361

(22) Filed: May 26, 2011

(30) Foreign Application Priority Data
Jun. 29, 2010 (JP) 2010-148189

(51) Int. Cl. H04L 9/32; G06F 21/00

(52) U.S. Cl. 726/7; 726/3

(57) ABSTRACT

A network authentication method is disclosed. A transmission-side client and a reception-side client have the same password. The transmission-side client transmits multiple authentication packets to the reception-side client at a slot interval according to an authentication code generated based on the password. The reception-side client measures a slot interval corresponding to the arrival timings of the respective authentication packets and then generates an authentication code based on the same password. The reception-side client compares the measured slot interval with the generated authentication code. When the two comparison targets are identical, the reception-side client concludes that the authentication is successful and transmits packets that have not been transmitted until such moment to a layer higher than an Internet layer.

### PRIORITY CLAIM

The present application claims benefit of priority under 35 U.S.C. §§120, 365 to the previously filed Japanese Patent Application No. JP2010-148189 entitled, “COMPUTER ACCESS METHOD AND COMPUTER” with a priority date of Jun. 29, 2010, which is incorporated by reference herein.

### BACKGROUND

1. Technical Field

The present invention relates to computer security in general, and in particular to a method for ensuring the security of computers connected to a network.

2. Description of Related Art

Computers connected to a network are exposed to attacks from malicious software (malware) such as computer viruses or spyware. A virus program is generally not harmful if it is not executed. However, if there are vulnerabilities in an operating system (OS) or an application, a computer may be controlled by malware just by accessing a specific Web page or opening a received document file.

For example, an attack method called a buffer overflow is known. This attack method aims to overflow a buffer region by transmitting data containing a virus code through a network to thereby rewrite a legitimate return address as a return address of the virus code. In this case, the computer will be controlled by a virus just by being connected to a network. There has been known a method of preventing penetration by malware via blocking access through network authentication, which is realized by forming a secure communication path using a Secure Sockets Layer (SSL) and transmitting passwords and user IDs, or by a firewall which uses methods such as packet filtering or an application layer gateway.

For example, one prior art discloses a technique in which when a large quantity of encrypted data with a sender address rewritten with a malicious intention are received, the data are not decoded but it is determined whether or not a legitimate packet has been received. A transmitting device encodes transmission target data to obtain encoded data and transmits the encoded data to a receiving device through a network in a state where validity proving information for proving validity to only the receiving device is added in a non-encoded state. The receiving device determines whether the validity of the validity proving information appended to the encoded data received through the network has been maintained and performs decoding of the encoded data only when the validity is determined to be maintained.

Another prior art discloses a technique of authenticating an access requester using time information. A time information acquisition section of an access requesting terminal performs digital signing on the time information which the time information acquisition section has acquired from a clock source through a transceiver section of an NTP server and transmits the time information to an access authentication server together with a public key certificate issued by a certification authority system. The access authentication server decodes the digitally signed time information using a public key and compares the decoded time information with the time information acquired from the NTP server. When the comparison result is within the range of a reference period indicated by a predetermined authentication parameter, the access authentication server permits access to the access requester from the access requesting terminal and does not permit access if it is outside the range.

### SUMMARY

In accordance with a preferred embodiment of the present invention, a transmission-side client and a reception-side client possess the same password. The transmission-side client transmits multiple authentication packets to the reception-side client at a slot interval according to an authentication code generated based on the password. The reception-side client measures a slot interval corresponding to the arrival timings of the respective authentication packets and then generates an authentication code based on the same password. The reception-side client compares the measured slot interval with the generated authentication code. When the two comparison targets are identical, the reception-side client concludes that the authentication is successful and transmits packets that have not been transmitted until then to a layer higher than an Internet layer.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a diagram of a network environment according to an embodiment of the present invention;

FIG. 2 is a block diagram showing a hardware configuration of a client computer or a server computer;

FIG. 3 is a diagram showing a hierarchical structure of a communication function installed in a computer;

FIG. 4 is a diagram showing a data structure of an Ethernet frame;

FIG. 5 is a block diagram of a transmission-side authentication system;

FIG. 6 is a block diagram of a reception-side authentication system;

FIG. 7 is a diagram showing a data structure of an authentication packet including an Echo request packet;

FIG. 8 is a diagram illustrating an authentication code generation method by a transmission-side authentication code generation section and a reception-side authentication code generation section;

FIGS. 9A and 9B are diagrams illustrating an authentication method using an authentication packet sequence;

FIG. 10 is a flowchart showing an authentication procedure;

FIG. 11 is a diagram illustrating a method of transmitting an authentication packet sequence;

FIG. 12 is a diagram showing a new data structure of an authentication packet sequence using a 4-valued interval symbol; and

FIGS. 13A and 13B are diagrams illustrating a method of authenticating multiple users.

### DETAILED DESCRIPTION OF A PREFERRED EMBODIMENT

### A. Network Environment

FIG. 1 is a diagram of a network environment according to an embodiment of the present invention. Clients 11a and 11b are connected to the Internet 10 through a router 13. A client 11c, a Web server 15b, a proxy server 15a, a Network Time Protocol (NTP) server 15d are directly connected to the Internet 10. A database server 15c and clients 11d and 11e connected to an intranet are connected to the Internet 10 through the proxy server 15a. In this example, the Web server 15b is configured to permit only access of a user who has been approved in advance. The NTP server 15d provides standard time information to computers connected to the Internet 10.

The respective clients 11a to 11e operate as a server so as to perform peer-to-peer communication in response to access from other clients. Moreover, the respective clients 11a to 11e also access the Web server 15b. The respective clients 11a to 11e normally close all ports constantly when operating as a computer that receives services from a server. However, the respective clients 11a to 11e need to open a predetermined port constantly when operating as a computer that provides services to other clients.

When the clients 11a to 11e operate as a server, security problems may occur. Moreover, although the server 15b is generally protected by a robust firewall or an authentication system, since it is necessary to perform authentication processing after it receives all packets from the user, there is a possibility of attacks in various ways such as a buffer overflow. The authentication system according to the present invention ensures network security by being installed in the clients 11a to 11e, the Web server 15b, the proxy server 15a, the router 13, or the database server 15c.

### B. The Configuration of a Computer

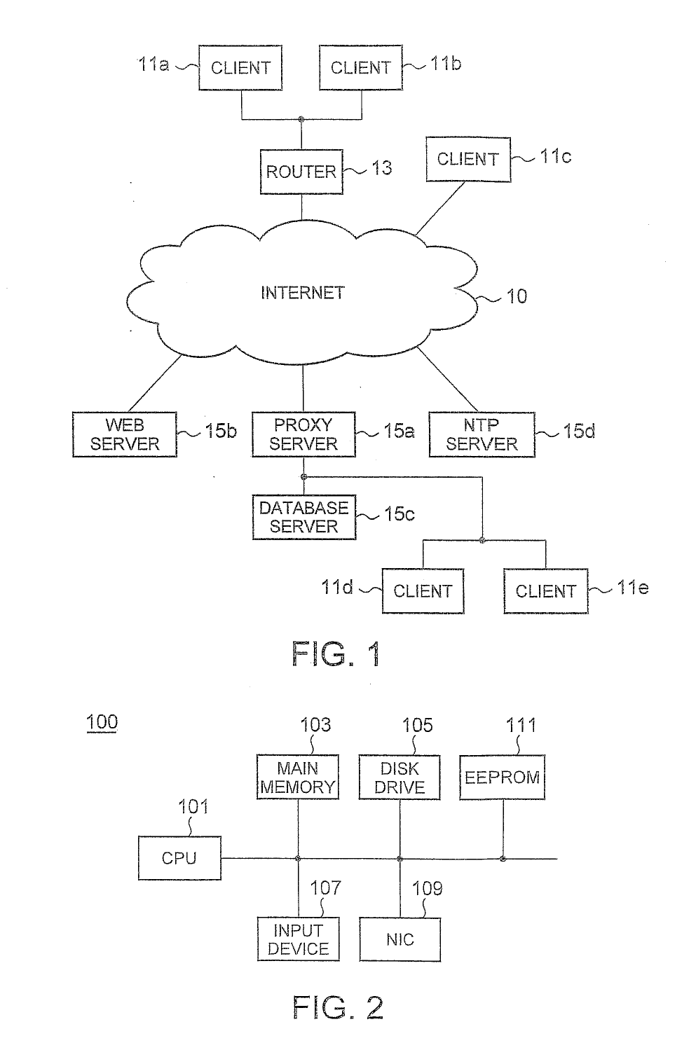

FIG. 2 is a block diagram showing a hardware configuration of a computer 100 for implementing the clients 11a to 11e, the Web server 15b, the proxy server 15a, the router 13, and/or the database server 15c shown in FIG. 1. The computer 100 includes a CPU 101, a main memory 103, a disk drive 105, an input device 107, a Network Interface Card (NIC) 109, a nonvolatile memory (EEPROM) 111 including a secure storage region, and the like. The disk drive 105 stores a program realizing the authentication system according to the present embodiment, an OS including network hierarchical modules, and programs executed by the CPU 101 such as various application programs.

The NIC 109 is hardware that operates on the data link layer and physical layer of the OSI reference model in order to connect the computer 100 to a network. In the present invention, the computer is not limited to a computer that is connected to a network in a wired manner but may be connected in a wireless manner. The secure storage region of the EEPROM 111 stores passwords and user IDs used in the present embodiment. The configuration of the computer 100 can be applied to both an authentication requesting computer and an authenticating computer.

### C. The Hierarchical Structure of a Communication Function

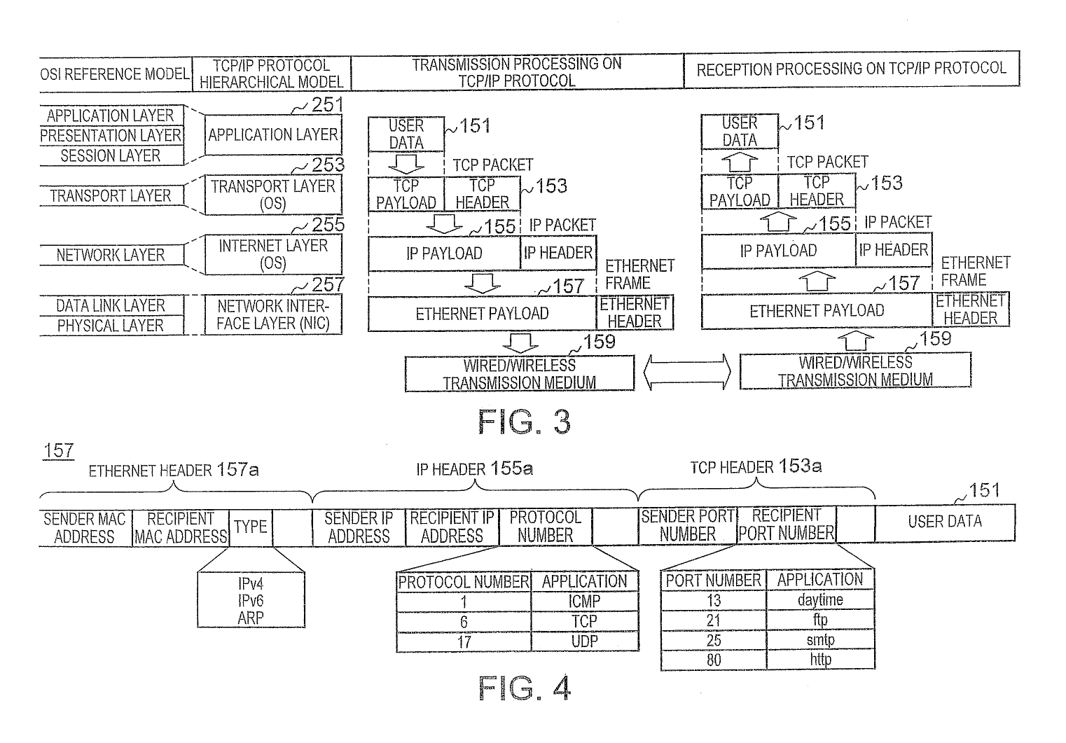

FIG. 3 is a diagram showing a hierarchical structure of a communication function installed in the computer 100. FIG. 4 is a diagram showing a typical data structure of an Ethernet frame. The communication function of the computer 100 operating as any of the transmission and reception sides can be expressed by the 7-layer OSI reference model and the corresponding 4-layer Transmission Control Protocol/Internet Protocol (TCP/IP) hierarchical model.

An application layer 251 positioned on the uppermost layer of the TCP/IP protocol hierarchical model is present in a form such that it includes an application layer, a presentation layer, and a session layer of the OSI reference model. The application layer 251 defines protocols such as HTTP, FTP, and SMTP in accordance with the kind of services such as mail or file transmission and realizes functions such as code conversion and establishment or disconnection of a communication path.

A transport layer 253 corresponds to the transport layer of the OSI reference model. The transmission-side transport layer 253 recognizes which protocol of the reception-side application layer 251 the user data 151 received from the transmission-side application layer 251 is to be passed to and creates a TCP header 153a. In addition, the transmission-side transport layer 253 appends the TCP header 153a to the user data 151 to create a TCP packet 153 and transmits the TCP packet 153 to an Internet layer 255. The TCP header 153a includes a sender port number and a recipient port number.

The reception-side transport layer 253 reads out the recipient port number from the TCP header 153a of the TCP packet 153 received from the Internet layer 255, deletes the TCP header 153a, and passes the TCP packet 153 to a corresponding service of the application layer 251. The protocol of the transport layer 253 includes a connection-type TCP as well as a connectionless-type User Datagram Protocol (UDP).

The Internet layer 255 corresponds to the network layer of the OSI reference model. The transmission-side Internet layer 255 appends an IP header 155a to the TCP packet 153 received from the transport layer 253 and transmits the TCP packet 153 to a network interface layer 257. The IP header 155a includes a sender IP address, a recipient IP address, and a protocol number. The protocol number is a number that indicates a protocol of a higher layer and specifies Internet Control Message Protocol (ICMP), TCP, UDP, or the like.

The reception-side Internet layer 255 deletes the IP header 155a when the recipient IP address of the IP packet 155 received from the network interface layer 257 is determined to be its own address and transmits the TCP packet 153 to the transport layer 253. The transport layer 253 and the Internet layer 255 are formed by an operating system.

The network interface layer 257 is present in a form such that it includes the data link layer and the physical layer of the OSI reference model. The transmission-side network interface layer 257 appends an Ethernet header 157a to the IP packet 155 received from the Internet layer 255 and outputs the IP packet 155 to the Internet 10 through a transmission medium 159. The Ethernet header 157a includes a sender MAC address, a recipient MAC address, and a type.

The type is a number corresponding to a protocol such as IPv4, IPv6, or ARP, and defines a protocol of an Ethernet payload included in the Ethernet frame 157. The reception-side network interface layer 257 deletes the Ethernet header 157a when the recipient MAC address of the Ethernet frame 157 received from the transmission medium 159 is determined to be its own address and transmits the IP packet 155 to the Internet layer 255 corresponding to a protocol indicated by the type. The network interface layer 257 includes the NIC 109 and a device driver controlling the NIC 109.

### D. Authentication System

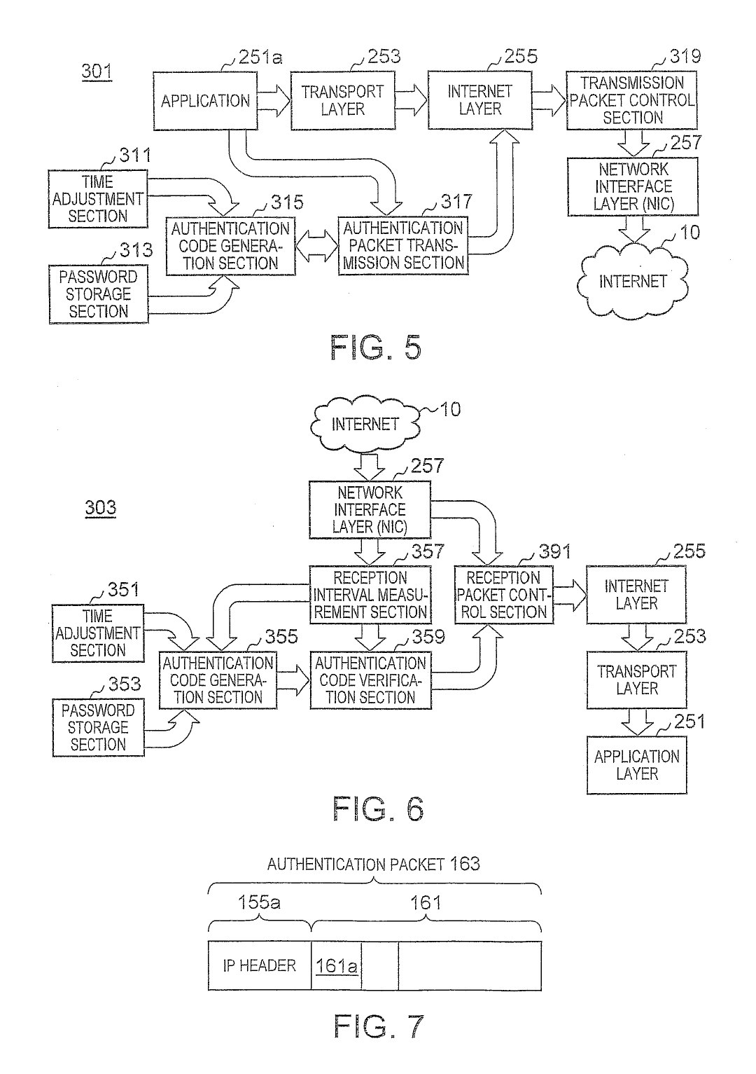

FIGS. 5 and 6 are block diagrams showing a configuration of an authentication system installed in the computer 100. Specifically, FIG. 5 shows a transmission-side authentication system 301, and FIG. 6 shows a reception-side authentication system 303. Although the two authentication systems are installed when the computer 100 operates as both a client and a server, only the authentication system 301 is installed when the computer 100 operates only as a client, and only the authentication system 303 is installed when the computer 100 operates only as a server. The authentication systems 301 and 303 are realized by collaboration of an OS that realizes the known TCP/IP protocol hierarchy or UDP/IP protocol hierarchy shown in FIG. 3 and a new program module according to the present embodiment.

The transmission-side authentication system 301 includes a time adjustment section 311, a password storage section 313, an authentication code generation section 315, an authentication packet transmission section 317, and a transmission packet control section 319. The time adjustment section 311 is a daytime protocol application that provides a service of the port number 13 and synchronizes the time of the computer 100 by periodically querying the NTP server 15d about time. The password storage section 313 is provided in the secure storage region of the EEPROM 11 and stores personal authentication passwords set by users and a shared authentication password that is set by an administrator so as to be shared by the respective users.

The authentication code generation section 315 generates an encrypted authentication code having a predetermined number of bits from the corrected time information which is possessed by the computer 100 and acquired from the time adjustment section 311 and the personal authentication passwords and shared authentication password acquired from the password storage section 313 based on a request from the authentication packet transmission section 317. Upon receiving a notification from an application 251a of the application layer 251, informing that it will access a specific computer which requires authentication, the authentication packet transmission section 317 generates an authentication packet sequence including a plurality of authentication packets which is transmitted in predetermined transmission time slots to the computer based on the authentication code received from the authentication code generation section 315.

The authentication packet transmission section 317 sets a reference time tx with respect to a transmission time of a leading time slot 174S (see FIGS. 9A and 9B) among the plurality of time slots formed in order to generate the authentication packet sequence. The reference time tx used by the transmission-side authentication system 301 is identical to a reference time ty used by the reception-side authentication system 303. The authentication packet transmission section 317 acquires the reference time tx from the time adjustment section 311 and requests the authentication code generation section 355 so as to generate an authentication code.

Since the content of the respective authentication packets constituting the authentication packet sequence will not be decoded by a reception-side computer in the course of authentication, any type of packets can be used as long as they are delivered to the reception-side computer. However, the use of ICMP packets is preferable since a notification of authentication success can be sent on a lower layer than the application layer. When the authentication packet transmission section 317 issues a ping command to the Internet layer 255, an ICMP module of the Internet layer 255 generates a packet (Echo Request) of an Echo request, and the authentication packet can be transmitted from the MC 109 of the network interface layer 257 to the Internet 10.

FIG. 7 is a diagram showing a data structure of an authentication packet including an Echo request packet. An authentication packet 163 includes the IP header 155a and an ICMP message 161. The ICMP message 161 includes a TYPE field 161a that maintains a number 3 assigned to an Echo request. The transmission packet control section 319 possesses an IP address of the reception-side computer that requires authentication. The transmission packet control section 319 has a function of a gate that temporarily suspends data packets which the application 251a transmits to the reception-side computer requiring authentication in a buffer. The period of suspension may be a predetermined period in which authentication is thought to be complete or a period elapsed until a notification of authentication success is received.

The transmission packet control section 319 can receive an ICMP packet (Echo Reply) of an Echo reply to the Echo request from the reception-side computer. The transmission packet control section 319 can determine that authentication is successful when the ICMP packet of an Echo reply is received and transmit the suspended data packets from the network interface layer 257 to the Internet 10. The authentication is performed in a transparent manner, and the application 251a does not recognize that authentication is being performed by the reception-side computer.

The reception-side authentication system 303 includes a time adjustment section 351, a password storage section 353, an authentication code generation section 355, a reception interval measurement section 357, an authentication code verification section 359, and a transmission packet control section 391. The time adjustment section 351, the password storage section 353, and the authentication code generation section 355 have the same functions as those of the time adjustment section 311, the password storage section 313, and the authentication code generation section 315 of the transmission-side authentication system 301.

When the authentication packets 163 arrive, the reception interval measurement section 357 specifies reception time slots corresponding to reception timings of the respective authentication packets 163 based on a time slot having the same slot period as the slot period of the time slot used by the transmission-side authentication packet transmission section 317, measures the slot interval of the reception time slots, and informs the authentication code verification section 259 of the measured slot interval. At that time, the reception interval measurement section 357 transmits the authentication packets 163 of which the slot interval is measured to the authentication code verification section 359. The reception interval measurement section 357 sets a reference time ty with respect to a leading time slot 174R (see FIGS. 9A and 9B) from the authentication packets 163 and requests the authentication code generation section 355 so as to generate an authentication code at a present time acquired from the time adjustment section 351.

Since the authentication code generation section 355 generates the authentication code at the present time when a request is received from the reception interval measurement section 357, the present time is identical to the reference time ty. As will be described later, the reference time ty can be set based on the reception time of a preamble which is send earlier than the authentication packets 163 or the reception time of the beginning authentication packet 163. The authentication code verification section 259 verifies the slot interval of the reception time slots received from the reception interval measurement section 357 and the authentication code acquired from the authentication code generation section 355 so as to determine whether or not authentication is successful. When authentication is determined to be successful, the authentication code verification section 359 sends a notification of authentication success to the reception packet control section 391. At that time, the authentication code verification section 259 transmits authentication packets 163 which have been successfully authenticated to the reception packet control section 391.

The reception packet control section 391 discards all authentication packets 163 and data packets received from the network interface layer 257 until it receives the notification of authentication success from the authentication code verification section 359 without transmitting them to the Internet layer 255. When the notification of authentication success is received from the authentication code verification section 359, the reception packet control section 391 transmits the authentication packets 163 received from the authentication code verification section 359 to the Internet layer 255.

Upon receiving the authentication packet 163 of an Echo request in response to the success in authentication of the authentication code verification section 359, the ICMP module of the Internet layer 255 sends back an Echo reply packet with respect to the Echo request. The reception packet control section 391 having received the notification of authentication success transmits only data packet including an IP address included in the authentication packet 163 received from the network interface layer 257 later than the notification of authentication success to the Internet layer 255.

The authentication code generation sections 315 and 355, the authentication packet transmission section 317, the transmission packet control section 319, the reception interval measurement section 357, the authentication code verification section 359, and the reception packet control section 391 are configured by a new program provided by the present embodiment and causes the computer 100 to realize the respective functions by being executed by the CPU 101 in collaboration with the OS. That is, the authentication system according to the present embodiment only controls the packets passed to the OS and does not add any change to the packet processing of the OS. Therefore, the authentication system can coexist with another authentication system which is employed in the OS or applications.

### E. An Authentication Code Generation Method

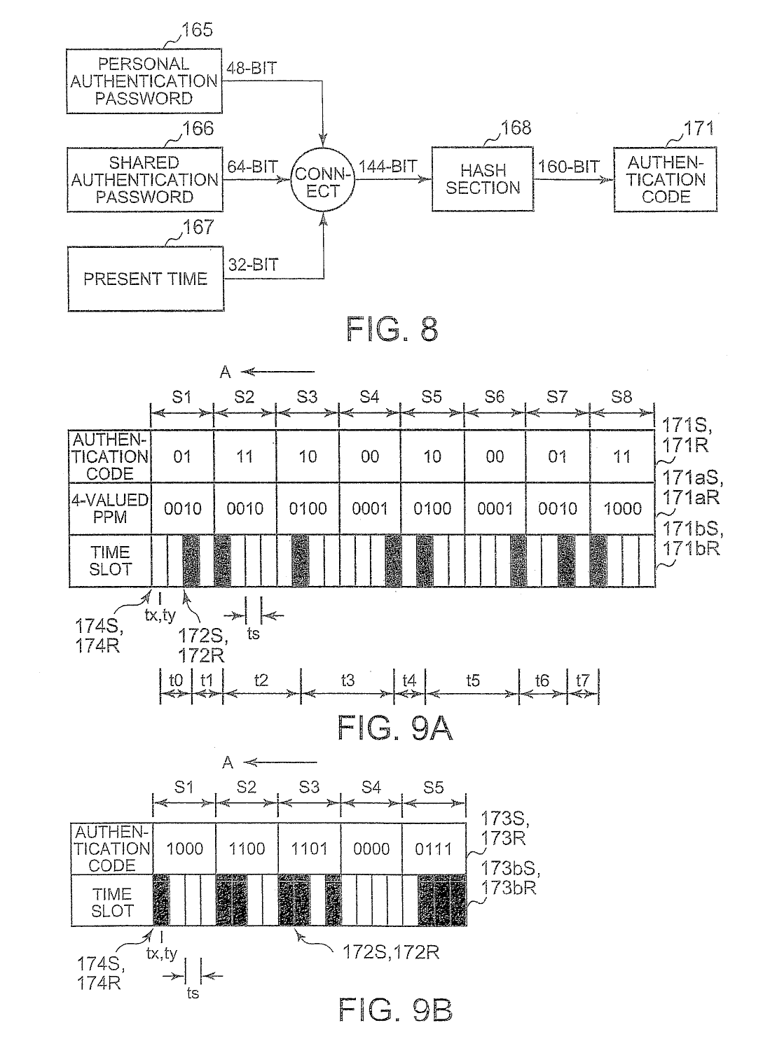

FIG. 8 is a diagram illustrating an authentication code generation method by the transmission-side authentication code generation section 315 and the reception-side authentication code generation section 355. In the password storage sections 313 and 353, a 48-bit personal authentication password and a 64-bit shared authentication password are stored. The personal authentication password 165 is made up of 8-character alphabets and numbers and is set and updated independently by respective users. The shared authentication password 166 is set and updated for all users managed by a network administrator.

The personal authentication password 165 and the shared authentication password 166 do not need to be separated and all the passwords may be regarded as personal authentication passwords. A present time 167 is possessed by the time adjustment sections 311 and 351 and is a present time which is possessed by the computer 100 and in which seconds corrected by the NTP server 15d are used as the minimum unit. A precision of about (200 ms is ensured for the time of the NTP server 15d. The authentication code generation sections 315 and 355 connect the respective bits of the personal authentication password 165, the shared authentication password 166, and the present time 167 to generate a bit string of 144 bits and generates a 160-bit hash value using a SHA-1 hash function.

The authentication code generation sections 315 and 355 extracts an authentication code 171 including a predetermined number of bit strings which continue from the leading bit of the hash value to the authentication packet transmission section 317. Since the authentication code 171 has a different value when the present time changes, the same authentication code will not be generated, and a high level of security against eavesdropping is ensured even when the authentication code 171 has a small number of bits.

The times of the transmission-side computer and the reception-side computer are synchronized by the authentication code 171 through the NTP server 15d. When the authentication packet transmission section 317 transmits the authentication packet 163 right after the reference time tx is raised by one second, the reception interval measurement section 357 receives the authentication packet 163 before the reference time tx is raised by one second and sets the reference time ty, thus making the reference time tx identical to the reference time ty. Therefore, it is possible to generate the same authentication code 171. Accordingly, the authentication code 171 corresponds to a shared key which is similar to a one-time password.

### F. Authentication Method Using Authentication Code

FIGS. 9A and 9B are diagrams illustrating an authentication method using an authentication packet sequence. Specifically, FIG. 9A shows an example of using a transmission timing pattern generated by modulating 16-bit authentication codes 171S and 171R “0111100010000111” by a 4-valued pulse-position modulation (PPM) method. FIG. 9B shows an example of using a transmission timing pattern generated from 4-bit codes which are divided from 20-bit authentication codes 173S and 173R “10001100110100000111” by a direct delivery method. FIGS. 9A and 9B show a state where the authentication packet 163 is transmitted and received in the direction indicated by an arrow A using black time slots sequentially from leading time slots 174S and 174R.

An authentication system 171S generated by the transmission-side authentication code generation section 315 is identical to an authentication code 171R generated by the reception-side authentication code generation section 355. In the case of FIG. 9A, upon receiving the 16-bit authentication code 171S from the authentication code generation section 315, the authentication packet transmission section 317 forms eight adjacent symbol periods S1 to S8 including four time slots of which slot period is ts. The slot period ts is determined based on a difference in the present time of the transmission-side computer and the reception-side computer, namely a fluctuation or the like of the transmission timings of the respective authentication packets 163.

The authentication packet transmission section 317 sequentially extracts two bits from the leading end of the 16-bit authentication code 171S to generate 4-valued PPM codes 171aS. The authentication packet transmission section 317 assigns the generated 4-valued PPM codes 171aS to the eight symbol periods S1 to S8 which are sequentially aligned and determines the positions of the time slots in the respective symbol periods S1 to S8 corresponding to the 4-valued PPM codes 171aS. The determined time slots in the respective symbol periods correspond to the transmission timings of the authentication packets 163. The black time slots corresponding to the transmission timings will be referred to as transmission time slots 172S.

The authentication packet transmission section 317 calculates slot intervals t0 to t7 between transmission time slots 174S which are integer multiples of the slot period and sequentially transmits authentication packets using the respective transmission time slots 172S. At this time, since the authentication packets 163 can become extinct while propagating through the Internet 10, a plurality of authentication packets 163 may be continuously transmitted in a short time interval of one transmission time slot 172S. The beginning slot interval t0 corresponds to a slot interval between the leading time slot 174S and the beginning transmission time slot 172S.

As shown in FIG. 9A, a group of authentication packets 163 transmitted using eight transmission time slots 172S will be referred to as an authentication packet sequence 171bS. When one authentication packet is transmitted using each transmission time slot 172S, the number of authentication packets 163 in one authentication packet sequence 171bS is identical to the number of transmission time slots 172S. When a plurality of authentication packets 163 is transmitted using each transmission time slot 172S, the number of authentication packets 163 is larger than the number of transmission time slots 172S.

In the 4-valued PPM method, since the authentication packet 163 is always transmitted from any one of the time slots in one symbol period, the number of transmission time slots 172S corresponding to the authentication code 171S having a predetermined number of bits is uniquely determined. Therefore, even when the authentication packet 163 corresponding to any one of the transmission time slots 172S of the authentication packet sequence 171bS is lost, it is easy to detect the packet loss on the reception side. When the 4-valued PPM method is used, if the slot period ts is 100 msec, 3.2 seconds are required to transmit one authentication packet sequence 171bS generated from the 16-bit authentication code 171S, and the bit transmission efficiency is 5 bit/second.

Upon receiving an authentication packet sequence 171bR from the network interface layer 257, the reception-side reception interval measurement section 357 forms the symbol periods S1 to S8 and time slots having the same slot period ts as the slot period ts of the time slots formed by the authentication packet transmission section 317. The reception interval measurement section 357 specifies time slots (hereinafter referred to as reception time slots 172R) in which the authentication packets 163 are received, constructs an authentication packet sequence 171bR, and calculates slot intervals t0 to t7 of the reception time slots 172R. The authentication code verification section 359 specifies the positions of the reception time slots 172R in the respective symbol periods based on the slot intervals t0 to t7 and the symbol periods S1 to S8 to calculate 4-valued PPM codes 171aR, and decodes an authentication code 171S from the 4-valued PPM codes 171aR.

In the case of FIG. 9B, the authentication packet transmission section 317 having received the 20-bit authentication code 1735 from the authentication code generation section 315 forms symbol periods S1 to S5 including four time slots of which the slot period is ts. The authentication packet transmission section 317 correlates the four time slots of the respective symbol periods S1 to S5 to the respective four bits extracted sequentially from the leading end of the authentication code 173S so as to determine transmission time slots 172S.

The reception interval measurement section 357 decodes the authentication code 173S from the positions of the reception time slots 172R in the respective symbol periods. When the direct delivery method is used, if the slot period is 100 msec, 2 seconds are required to transmit one authentication packet sequence 173bS generated from the 20-bit authentication code 173S, and the bit transmission efficiency is 10 bit/second. Although the direct delivery method provides high bit transmission efficiency, since one symbol period includes 0 to 4 transmission time slots 172S, it is difficult to verify the loss of the authentication packets 163 during transmission.

The authentication code 171S includes time information corresponding to the reference time tx set by the transmission-side computer. The reference time tx which is set at the center of the leading time slot 174S of the time slots formed in order to transmit the authentication packet sequences 171bS and 173bS is made approximately identical to the present time at which the authentication code generation section 315 acquires the time information from the time adjustment section 311 in order to create the authentication code 171S. The reception-side computer needs to set the reference time ty based on the received authentication packet 163.

However, it is not always true that the leading time slot 174S of the authentication packet sequences 171bS and 173bS is the transmission time slot 172S. Therefore, even when the authentication packet 163 is arrived in a short period, the reception-side computer may be unable to set the reference time ty to the leading time slot 174R of the symbol period S1 at the reception time of the beginning authentication packet 163, and the authentication code generation section 355 may be unable to generate the authentication codes 171R and 173R at the reference time ty.

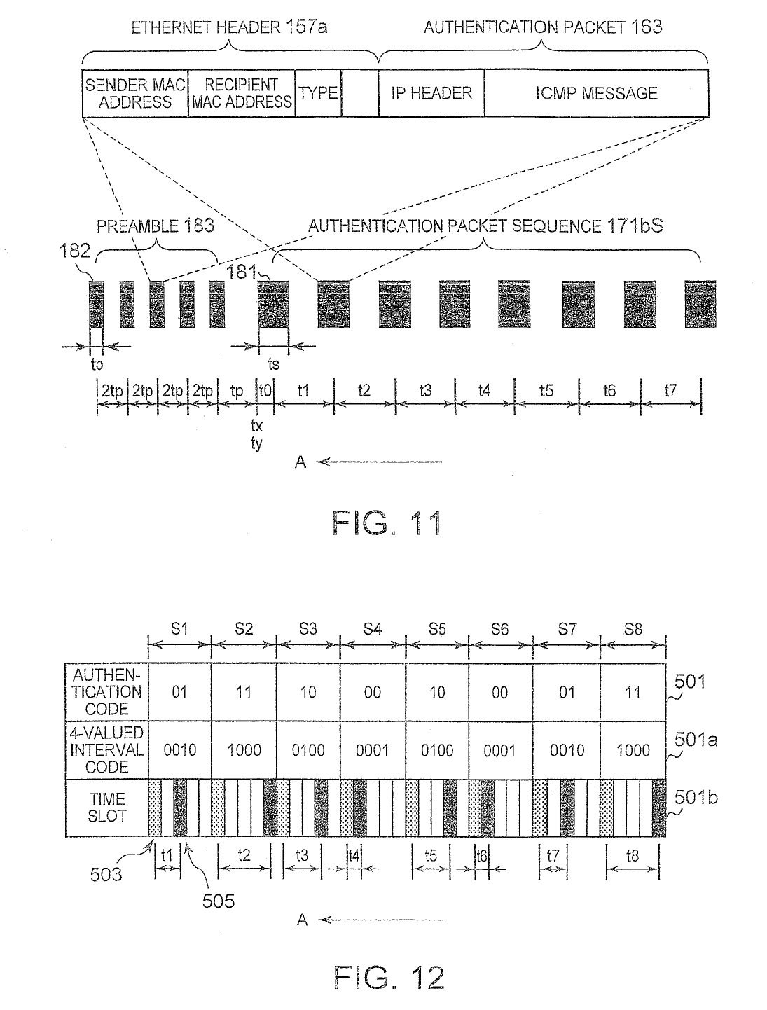

In the present embodiment, as one method of setting the reference time ty with respect to the leading time slot 174R, a preamble is appended to the leading ends of the authentication packet sequences 171bS and 173bS. The data structure of an Ethernet frame having a preamble appended thereto will be described later with reference to Figure 11. In any of the PPM method and the direct delivery method, the number of time slots included in one symbol period is not limited to that illustrated in FIGS. 9A and 9B.

### G. Authentication Procedure

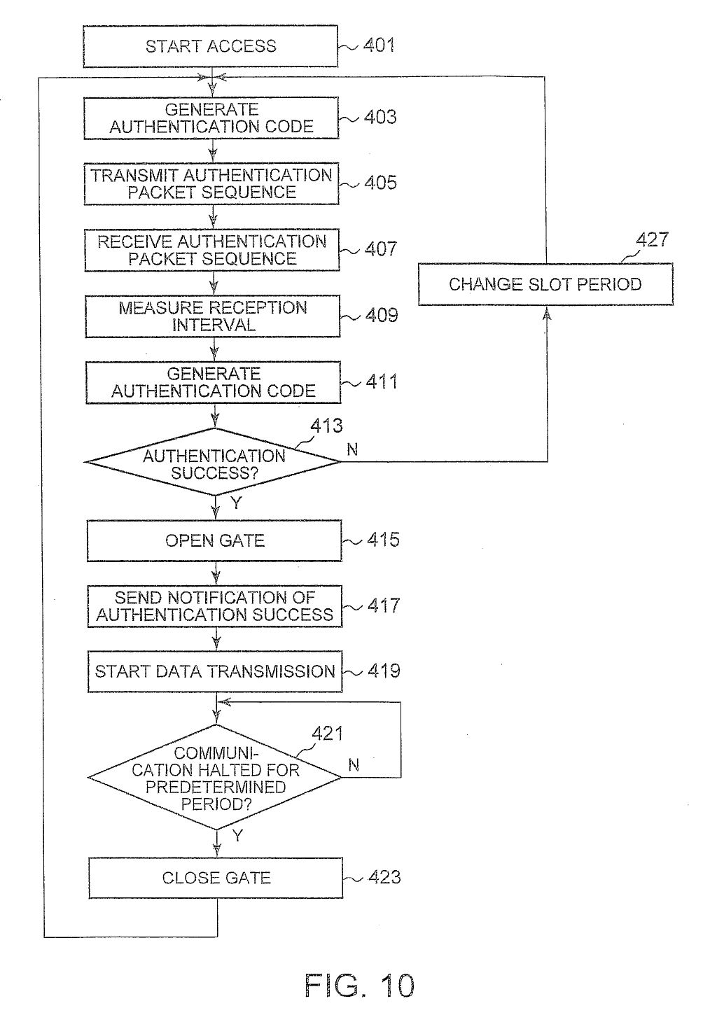

Next, an authentication procedure when the client 11a having the transmission-side authentication system 301 accesses the client 11c having the reception-side authentication system 303 using the authentication packet sequence 171bS of FIG. 9A will be described. FIG. 10 is a flowchart showing an authentication procedure. The clients 11a and 11c are configured as the computer 100, and the transmission-side authentication system 301 and the reception-side authentication system 303 are installed in the clients 11a and 11c, respectively. As a typical example, a case in which the same user accesses the client 11c operating as a home server from the client 11a present at a remote site can be considered.

The client 11c receives packets from a malicious client connected to the Internet 10 as well as the reliable client 11a. Although the OS of the reception-side client 11c opens ports for communicating with the client 11a on the transport layer 253, the reception packet control section 391 closes gates until it receives a notification of authentication success from the authentication code verification section 359 and discards all IP packets received from the network interface layer 257.

All malicious Ethernet frames which are not authenticated by the authentication method of the present embodiment are processed by the NIC 109 of the network interface layer 257, the reception interval measurement section 357, and the authentication code verification section 359. The NIC 109 has high attack resistance since it processes Ethernet frames with hardware. Moreover, as will be described later, the reception interval measurement section 357 and the authentication code verification section 359 acquire only the information on the arrival timings from the received IP packets until authentication is complete and discards the arrival timings if authentication is not successful. Therefore, there is no need to decode the IP header or the IP payload, and there is no risk.

Moreover, although the client 11c may receive a large quantity of malicious packets, the reception interval measurement section 357 just calculates the reception timings of all the received packets and does not perform such processing of connecting packetized data as performed on the transport layer 253. Thus, the large quantity of malicious data will not be stored in the main memory 103. It is assumed that the IP address of the reception-side client 11c is fixed. Moreover, the transmission-side password storage section 313 and the reception-side password storage section 353 store the same personal authentication password 165 and the same shared authentication password 166.

In block 401, the transmission-side application 251a passes user data including the IP address of the client 11c to the transport layer 253 to start an operation of establishing a session with the client 11c and transmits an IP packet to the transmission packet control section 319 through the transport layer 253 and the Internet layer 255. The transmission packet control section 319 stores the IP packet of which the recipient is the client 11c in a buffer until it receives an ICMP packet of an Echo reply representing authentication success from the client 11c. In the present embodiment, access from the application 251a to the client 11c is performed in a transparent manner.

To the user, the presence of the authentication systems 301 and 303 is recognized just as the inability to access resulting from the unauthenticated reply from the client 11c with respect to the application 251a or a very short delay until authentication is successful. In block 403, the application 251a sends a notification to the authentication packet transmission section 317, informing that it starts accessing the client 11c.

The authentication packet transmission section 317 having received the notification requests the authentication code generation section 315 to generate the authentication code 171S. As shown in FIG. 8, the authentication code generation section 315 acquires the present time possessed by the client 11a from the time adjustment section 311 and acquires the personal authentication password 165 and the shared authentication password 166 from the password storage section 313, and connects them to obtain connected data. Then, the authentication code generation section 315 hashes the connected data to generate the authentication code 171S.

In block 405, the authentication packet transmission section 317 forms the time slots having a slot period of ts and transmits the authentication packet sequence 171bS generated by the 4-valued PPM method based on the authentication code 171S shown in FIG. 9 in accordance with the timings of the respective transmission time slots 172S. The authentication packet sequence 171bS includes a plurality of authentication packets 163 each including the ICMP message 161. As shown in FIG. 11, the authentication packet transmission section 317 transmits a preamble 183 before the Ethernet frame 181 which is transmitted first among the authentication packet sequence 171bS.

FIG. 11 is a diagram illustrating a method of transmitting the authentication packet sequence 171bS. The preamble 183 includes a plurality of preamble packets which is transmitted every other time slot among a plurality of consecutive time slots having a slot period of tp. The preamble 183 is designed to acquire the reference time ty which the client 11c sets to the leading time slot 174R of the symbol period S1 and which is used when the authentication code generation section 355 generates the authentication code 171R. Therefore, the data structure of the preamble packet may be the same as or different from the authentication packet 163 as long as it includes the IP header 155a. In the present embodiment, the five Ethernet frames 181 constituting the authentication packet sequence 171bS and the eight Ethernet frames 182 constituting the preamble 183 are configured to include the authentication packet 163.

The authentication packet transmission section 317 observes the time information, of which the minimum unit is one second, received from the time adjustment section 311 and sets the reference time tx to the leading time slot 174S in order to transmit the authentication packet sequence 171bS. At that time, the authentication packet transmission section 317 transmits the preamble 183 earlier than the reference time tx so that the reference time ty set to the leading time slot 174R by the reception-side reception interval measurement section 357 is identical to the reference time tx of which the unit is one second, and adjusts the transmission timing so that the authentication packet sequence 171bS can be transmitted at the reference time tx right after it is raised by one second.

Since the minimum units of the reference time tx and the reference time ty are one second, if the packet transmission time is sufficiently shorter than one second, the reference time ty of the leading time slot 174R of the reception interval measurement section 357 specified by the preamble 183 is identical to the reference time tx set to the leading time slot 174S by the authentication packet transmission section 317. The Ethernet header 157a is appended to the authentication packet 163, and the authentication packet 163 is transmitted from the NIC 109 to the counterpart computer as an Ethernet frame.

When transmitting the authentication packet sequence 171bS, the client 11a appends the preamble 183 to the leading end of the authentication packet sequence 171bS. The Ethernet frames 181 and 182 include the Ethernet header 157a and the authentication packet 163. In the IP header of the authentication packet 163, the IP address of the client 11c is recorded as a recipient address. The five Ethernet frames 181 and the eight Ethernet frames 182 are sequentially transmitted from the client 11a at predetermined slot intervals t0 to t7 in the direction indicated by arrow A.

The authentication packet transmission section 317 forms 10 consecutive time slots having a slot period of tp used for the preamble packet and 32 consecutive time slots adjacent to the time slots, having a slot period of is used for the authentication packet 163. The authentication packet transmission section 317 first transmits five Ethernet frames 182 at a slot interval of 2tp for the preamble 183, sets the reference time tx of the leading time slot 174S after the elapse of a slot period tq from the transmission of the fifth Ethernet frame 182, and transmits the leading Ethernet frame 181 after the elapse of 2 slot intervals corresponding to a slot interval of t0 from the leading time slot 174S. The slot interval tq can be calculated by tp+(tp+ts)/2.

At that time, the authentication packet transmission section 317 first transmits the preamble 183 and requests the authentication code generation section 315 to generate the authentication code 171 so that the authentication code 171S is generated at the reference time tx of the leading time slot 174S. Then, upon receiving the authentication code 171S generated at the reference time tx from the authentication code generation section 315, the authentication packet transmission section 317 generates the transmission time slot 172S and transmits the authentication packet sequence 171bS in which the leading time slot 174S is set to the reference time tx occurring after the elapse of the slot period tq. Since the generation of the authentication code 171S by the authentication code generation section 315 and the generation of the authentication packet sequence 171bS by the authentication packet transmission section 317 are performed in a very short period, the reference time tx of which the unit is one second can be used for the generation of the authentication code 171S and the generation of the leading time slot 174S.

The authentication packet transmission section 317 can correlate the slot period tp of the preamble 183 with the slot period ts of the authentication packet sequence 171bS. As an example, the authentication packet transmission section 317 may correlate the slot periods tp of 15 msec, 20 msec, and 25 msec with the slot periods ts of 80 msec, 100 msec, and 120 msec, respectively, whereby the reception-side client 11c can calculate the slot period tp of the received preamble 183 to specify the slot period ts of the authentication packet sequence 171bS. Therefore, the slot period ts used by the clients 11a and 11c can be changed dynamically in accordance with the transmission speed of the Internet 10.

The authentication packet transmission section 317 first sets the slot period tp to the smallest 15 msec and sets the slot period ts to 80 msec in a corresponding manner. The authentication packet transmission section 317 sets the reference time tx of the leading time slot 174S after the elapse of the slot period tq from the transmission of the fifth Ethernet frame 182, and transmits the leading Ethernet frame 181 after the elapse of t0. Subsequently, the authentication packet transmission section 317 transmits the remaining seven Ethernet frames 181 at the slot intervals t1 to t7. When one Ethernet frame 181 is transmitted in each slot period ts, the Ethernet frame is transmitted at the center of the slot period. When a plurality of Ethernet frames 181 is transmitted in each slot period ts, the Ethernet frames are transmitted to be distributed back and forth from the center of the slot period.

In block 407, the reception-side network interface layer 257 having received the Ethernet frames 181 and 182 extracts the authentication packet 163 which is the Ethernet payload whenever the Ethernet frames are received and transmits the authentication packets 163 to the reception interval measurement section 357 and the reception packet control section 391. The reception packet control section 391 transmits neither the IP packets nor the authentication packets 163 to the Internet layer 255 until it receives the notification of authentication success from the authentication code verification section 359. The reception interval measurement section 357 recognizes in advance that the first five authentication packets 163 correspond to the preamble 183.

Upon receiving the first five authentication packets 163, the reception interval measurement section 357 calculates the average arrival timing of the authentication packets 163 to acquire the slot period tp when the authentication packet transmission section 317 transmits the preamble 183. The reception interval measurement section 357 recognizes that the slot period ts is 80 msec by recognizing that the slot period tp is 15 msec.

The reception interval measurement section 357 sets the reference time ty of the leading time slot 174R of the symbol period S1 to a time occurring after the elapse of the slot period tp from the arrival timing of the fifth authentication packet 163 and sets 32 time slots based on the reference time ty. The reception interval measurement section 357 acquires the time information from the time adjustment section 351 at the reference time ty and requests the authentication code generation section 355 to generate the authentication code 171R. Since the transmission speed of the Ethernet frame 182 of the preamble 183 is sufficiently fast, the reference time tx of which the unit is one second is identical to the reference time ty.

The reception interval measurement section 357 can recognize the slot period ts used by the authentication packet transmission section 317 by receiving the preamble 183 before the authentication packet sequence 171bR. Moreover, the reception interval measurement section 357 can set the reference time ty to the leading time slot 174R using the pattern of the authentication code 171S even when the first time slot of the symbol period S1 is not the transmission time slot 172S. In block 409, the reception interval measurement section 357 specifies the reception time slot 172R from the arrival timing of the eight continuously received authentication packets 163 to calculate the slot interval and transmits the calculated slot interval to the authentication code verification section 359. Moreover, the reception interval measurement section 357 transmits the authentication packets 163 of which the slot interval is calculated to the authentication code verification section 359.

Even when a plurality of Ethernet frames 181 is transmitted using one transmission time slot 172S, and the arrival of a plurality of authentication packets 163 is detected using one reception time slot 172R, the reception interval measurement section 357 specifies one reception time slot 172R. When the authentication packet sequence 171bS is configured by the 4-valued PPM method, the reception interval measurement section 357 can recognize in advance that eight reception time slots 172R are formed from the authentication packet sequence 171bS. Therefore, nothing is notified to the authentication code verification section 359 unless it is unable to specify eight reception time slots 172R.

In the above processing, the reception interval measurement section 357 does not decode the IP header 155a and the ICMP message 161 of the authentication packet 163. Moreover, since the above processing is performed by the NIC 109 which is hardware of the network interface layer 257, the client 11c will not be controlled by malware. In addition, since the maximum size of the Ethernet frames 181 and 182 is 1500 bytes, and processing of combining them is not performed by the NIC 111, the reception interval measurement section 357, and the authentication code verification section 359, buffer overflow will not occur.

In block 411, the authentication code generation section 355 having received the request to generate the authentication code 171 from the reception interval measurement section 357 immediately acquires the present time from the time adjustment section 351 and acquires the personal authentication password 165 and the shared authentication password 166 from the password storage section 353 to generate the authentication code 171R, and transmits the authentication code 171R to the authentication code verification section 359. The time when the authentication code generation section 355 generates the authentication code 171R from the time adjustment section 351 is the same as the reference time ty, and the authentication code 171S generated by the authentication code generation section 315 is identical to the authentication code 171R generated by the authentication code generation section 355.

In block 413, the authentication code verification section 359 calculates the 4-valued PPM codes 171aR for the respective symbol periods S1 to S8 from the slot intervals t0 to t7 received from the reception interval measurement section 357 and decodes the authentication code 171S from the 4-valued PPM codes 171aR. Moreover, the authentication code verification section 359 stores the authentication packets 163 received from the reception interval measurement section 357 in a buffer.

The authentication code verification section 359 compares the authentication code 171R received from the authentication code generation section 355 with the decoded authentication code 171S and determines that authentication is successful when they are identical. Alternatively, the authentication code verification section 359 may compare the slot interval calculated from the authentication code 171R received from the authentication code generation section 355 with the slot interval of the reception time slots 172R and determine that authentication is successful when they are identical. When determining that authentication is successful, the authentication code verification section 359 sends a notification of authentication success to the reception packet control section 391, and the flow proceeds to block 415. At that time, the authentication code verification section 359 transmits all the authentication packets 163 stored in the buffer to the reception packet control section 391.

In block 415, the reception packet control section 391 having received the notification of authentication success verifies whether or not the IP addresses of all the authentication packets 163 received from the authentication code verification section 359 are identical. If they are identical, the reception packet control section 391 opens the gates with respect to only the IP packets including the sender IP addresses received from the network interface layer 257 and transmits the IP packets to the Internet layer 255.

In order to pass only the IP packets from the IP addresses which are successfully authenticated, the reception packet control section 391 may need to decode the sender IP addresses of the authentication packets 163 but may omit verification as to whether or not the IP addresses of all the authentication packets 163 are identical. In block 417, the reception packet control section 391 transmits all the authentication packets 163 received from the authentication code verification section 359 to the Internet layer 255.

The ICMP module of the Internet layer 255 transmits an ICMP packet for sending an Echo reply to the Echo request to the client 11a. The ICMP packet is transmitted to the transmission packet control section 319 and the authentication packet transmission section 317. The IP packet is delivered to the Internet layer 255 of the client 11c for the first time, and the IP payload is analyzed. In this case, the IP packet is secure because it is received from the client 11a having the IP address which has been successfully authenticated.

In block 419, the transmission packet control section 319 having received the ICMP packet transmits the IP packet which includes the user data from the application 251a and is stored in the buffer to the network interface layer 257. Then, a session is established between the application 251a of the client 11a and the application layer 251 of the client 11c. The user data generated by the application 251a are later transmitted to the client 11c through the network interface layer 257 without being stored in the buffer of the transmission packet control section 319.

In block 421, the application 251a of the client 11a terminates the session. The session may be forcibly terminated by the user, and may be automatically terminated when the application 251a determines that there is no user access for a predetermined period. As a result, the Ethernet frame is not delivered from the client 11a to the client 11c. The reception packet control section 391 monitors the time interval of the IP packets which pass after the gates are opened, and closes the gates again in block 423 when no passing of IP packets is detected for a predetermined period.

At that time, the reception packet control section 391 can send an ICMP packet indicating the closing of gates to the client 11a. The transmission packet control section 319 having received the ICMP packet closes the gates and stores the IP packets received from the application 251a after that moment in the buffer. The application 251a having recognized the disconnection of the session with the client 11c initiates a new session in block 403 and can access the client 11c through an authentication procedure.

When determining in block 413 that no ICMP packet of an Echo reply indicating authentication success is received from the client 11c for a predetermined period, the authentication packet transmission section 317 of the client 11a changes the slot period tp of the preamble 183 to 20 msec and changes the slot period is of the authentication packet sequence 171bS to 100 msec in a corresponding manner in block 427, and then, the flow proceeds to block 403.

In block 403, the authentication packet transmission section 317 requests the authentication code generation section 315 to generate an authentication code 171S based on a new reference time tx. Upon receiving the new authentication code 171S from the authentication code generation section 315, the authentication packet transmission section 317 generates a new authentication packet sequence 171bS, sets the slot period tp to 20 msec, sets the slot period ts to 100 msec, and transmits a new preamble 183 and the authentication packet sequence 171bs.

When it is further determined in block 413 that authentication is not successful, the authentication packet transmission section 317 changes the slot period tp of the preamble 183 to 25 msec, sets the slot period ts of the authentication packet sequence 171bS to 120 msec in a corresponding manner, and transmits a new preamble 183 and the authentication packet sequence 171bS. Since the arrival time of the respective authentication packets 163 fluctuates due to various reasons while the authentication packet sequence 171bS is being transmitted along a transmission path, the probability of authentication success increases as the slot period ts increases. However, since the time up to complete the authentication increases as the slot period ts increases, the authentication can be completed in a shortest period by starting the authentication with the shortest slot period. Once the optimum slot period is set, the slot period may be fixed unless the connection form is changed.

### H. Other Transmission Method of Authentication Packet Sequence

When transmitting the authentication packet sequences 171bS and 173bS, It is necessary to transmit the preambles 183 at the same time. When the transmission speed of the communication path is stable, and the optimum slot period ts can be set from the beginning, the authentication packet sequence may be transmitted without appending the preamble 183 thereto. FIG. 12 is a diagram showing a new data structure of an authentication packet sequence using a 4-valued interval symbol.

It is assumed that an authentication code 501 has the same 16-bit value “0111100010000111” as that shown in FIG. 9A. The authentication packet transmission section 317 continuously extracts two bits from the leading end of the authentication code 171S and assigns them to the symbol periods S1 to S8. The respective symbol periods S1 to S8 include five time slots of which the slot period is ts. The authentication packet transmission section 317 modulates a 4-valued interval code 501a with respect to the respective symbol periods by a 4-valued interval symbol method to generate a 4-valued interval code 501a.

In the 4-valued interval code 501a, a start slot 503 is set to the leading time slots of the respective symbol periods, and the extracted 2-bit weight is expressed as the slot interval between the start slot 503 and a transmission time slot 505. In this example, the two bits “00” of the authentication code 501 is modulated to “0001” of the 4-valued interval code 501a to be assigned to one slot interval, “01” is modulated to “0010” to be assigned to two slot intervals, “10” is modulated to “0100” to be assigned to three slot intervals, and “11” is modulated to “1000” to be assigned to four slot intervals to generate an authentication packet sequence 501b.

The respective symbol periods S1 to S8 always include one transmission time slot 505. The reception interval measurement section 357 having received the authentication packet sequence 501b sets the time when the authentication packet 163 is received for the fist time to the center of the leading time slot 174R of the slot period S1 as the reference time ty, thus forming 20 time slots. Moreover, the reception interval measurement section 357 requests the authentication code generation section 315 to generate the authentication code 501 at the reference time ty. The reception interval measurement section 357 can decode the authentication code 501 by measuring the slot intervals t1 to t8 between the start slot 503 and the next reception time slot with respect to the respective symbol periods S1 to S8. When the 4-valued interval symbol method is used, if the slot period ts is 100 msec, the bit transmission efficiency is 4 bit/second.

Besides this, the authentication packet sequences 171bS and 173bS generated by the 4-valued PPM method or the direct delivery method can be also transmitted without appending the preamble thereto. In the authentication code generation section 315, a hash section 168 thereof calculates a 160-bit hash value by the method described in FIG. 8. In FIGS. 8, 9A, and 9B, since the authentication code generation sections 315 and 355 extract 16 or 20 consecutive bits from the 160-bit hash value, the authentication code 171S in which the leading bit is zero is present. Therefore, the reception interval measurement section 357 requires the preamble in order to set the reference time ty of the leading time slot 174R to generate the same authentication code 171R.

When the two authentication code generation sections 315 and 355 extract the 16- or 20-bit authentication code from the leading end (MSB) of the 160-bit hash value, if the leading time slot 174S is 0 and is not the transmission time slot 172S, the leading end positions of the authentication codes 171 and 173 are determined by shifting the leading bit toward the LSB side sequentially by one bit until the leading time slot 174S becomes the transmission time slot 172S. As a result, the two authentication code generation sections 315 and 355 can acquire the same 16- or 20-bit authentication code in which the leading time slot 174S is 1 and becomes the transmission time slot 172S.

For example, in order to obtain a 12-bit authentication code from a 160-bit hash value “01011001100100110001 . . . ” by the 4-valued PPM method, an authentication code of “110011001001” can be obtained by shifting the leading bit towards the LSB side by three bits. Moreover, in order to obtain a 10-bit authentication code by the direct delivery method, an authentication code of “1011001100” can be obtained by shifting the leading bit towards the LSB side by one bit. If it is guaranteed that the leading time slot 174S becomes the transmission time slot 172S, the reception interval measurement section 357 can set the reference time ty to the first reception time slot 172R even when the preamble 183 is not received.

### I. Application to Server

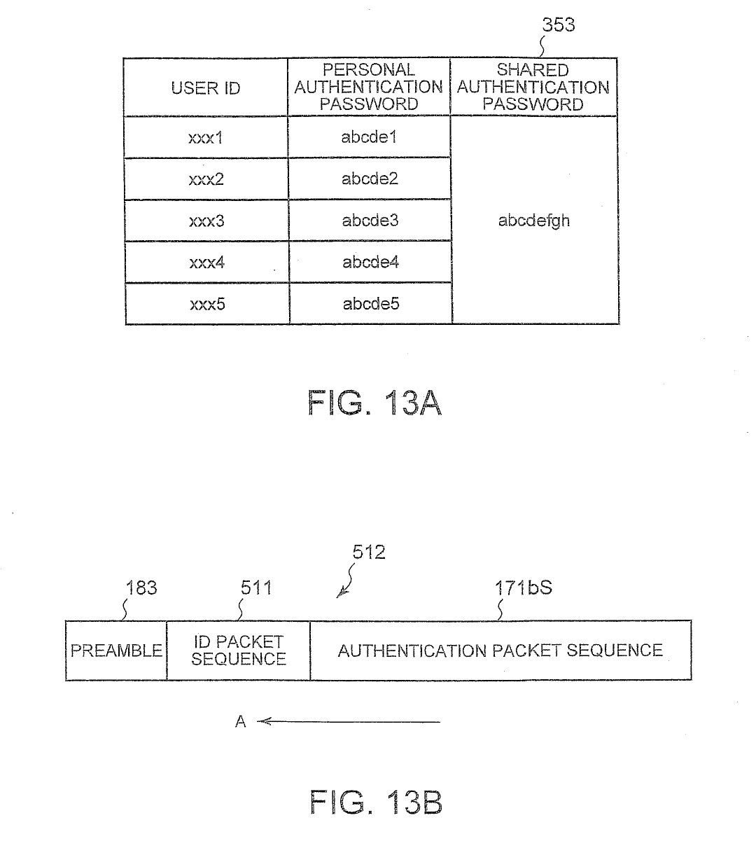

Next, an authentication method for allowing the Web server 15b to permit access from a plurality of permitted clients 11a to 11e will be described with reference to FIGS. 13A and 13B. The clients 11a to 11e have the transmission-side authentication system 301 installed therein and store the respective user IDs in the password storage section. The number of bits of the user ID is fixed to a predetermined value. The Web server 15b has the reception-side authentication system 303 installed therein, and as shown in FIG. 13A, the password storage section 353 stores the shared authentication password 166 and the user ID and the personal authentication password for each client.

The reception packet control section 391 includes a gate for each user ID. The authentication packet transmission section 317 of any of the clients transmits the authentication packet sequence 171bS in the procedure described in FIG. 10. At that time, the authentication packet transmission section 317 appends an ID packet sequence in which the user ID is expressed by the pattern of the transmission time slot 172S at the end of the preamble 183. The slot period of the ID packet sequence may be different from the slot period is of the authentication packet sequence 171bS. However, it is easy to process the ID packet sequence when the slot period thereof is the same as that of the authentication packet sequence 171bS.

The authentication packet transmission section 317 acquires the user ID from the EEPROM 11 and converts the user ID into a transmission timing pattern by the same method as that used for generating the authentication packet sequences 171bS, 173bS, and 501b, namely any one of the 4-valued PPM method, the direct delivery method, and the 4-valued interval symbol method to generate the ID packet sequence. FIG. 13B shows a data structure of a packet sequence 512 in which an ID packet sequence 511 is appended to the authentication packet sequence 171bS. The reception interval measurement section 357 of the Web server 15b having received the packet sequence 512 sets the reference time ty to the leading time slot of the ID packet sequence 512 continuous to the preamble 183 specifies a predetermined number of first reception time slots corresponding to the user ID.

The authentication code verification section 359 compares the user ID decoded from the ID packet sequence 511 with the user ID acquired from the password storage section 353, generates an authentication code from the personal authentication password, the shared authentication password, and the time information corresponding to the user ID, and authenticates the authentication code. With this configuration, the Web server 15b can authenticate the individual personal authentication passwords without applying the same personal authentication password to all users. Moreover, the Web server 15b can close all the gates of the reception packet control section 391 constantly and open only a gate corresponding to a specific gate when the specific user is authenticated, and transmit only the IP packet of a recipient IP address included in the authenticated authentication packet 163 to the Internet layer 255.

### J. Other Features

In block 417, the client 11c transmits an ICMP packet for sending an Echo reply to the client 11a so as to send a notification of authentication success. In the present embodiment, it is possible to establish a session even when the notification of authentication success is not sent. In this case, since the transmission packet control section 319 does not recognize the authentication success, the transmission packet control section 319 transmits the IP packets including the user data stored in the buffer to the network interface layer 257 after the elapse of a predetermined period from the transmission of the authentication packet 163.

At that time, when the client 11c does not authenticate the client 11a, since there is no reply to access from the application 251a, the application 251a sends a request for an authentication operation again to the authentication packet transmission section 317. Therefore, when the authentication packet 163 is transmitted through a router, the authentication packet 163 may have a format such that it can be routed and it includes at least the IP header 155a so that it can arrive at the client 11c. In addition, since the packets can be transmitted just with the MAC address if the clients belong to the same router, the IP address is not necessary.

Although FIG. 11 illustrates an example in which the authentication packet sequence 171bS and the preamble 183 are configured by an Ethernet frame including the IP packet, since in the present invention, the content of the Ethernet payload is not required in the authentication step, a UDP packet may be used instead of the IP packet. Moreover, although an example where the reception-side packet control section 391 is inserted between the network interface layer 257 and the Internet layer 255 in order to achieve the maximum security against attacks in a state of being connected to a network has been described, attacks on the application layer 251 generally cause the most severe damage.

For example, when a program operating under the authority of an administrator is controlled by a virus, the entire computer is controlled by the virus, and critical damage is caused. Therefore, inserting the reception packet control section 391 between the Internet layer 255 and the transport layer 253 so that TCP packets which are not authenticated are not passed to the transport layer 253 can be effective protection measures.

At that time, since all IP packets arrive at the network layer 255 and the IP headers of the authentication packets 163 are decoded before authentication, when the present invention is applied to the server 15b that authenticates a plurality of users, even when authentication packet sequences are simultaneously received from a plurality of users, and the arrival timings are different from each other, it is possible to authenticate the authentication packets 163 by arranging them on the time axis for each user based on the IP address.

The authentication system according to the present invention in a way pertains to a firewall in that it ensures the network security of computers in a transparent manner. Therefore, the authentication system according to the present invention can coexist with the existing authentication system. However, the firewall just limits packets that can be passed, and the individual computers need to ensure the security of the packets themselves which are permitted to pass. In contrast, since the authentication system according to the present invention checks the reliability of the IP packets in advance and then permits the access thereof to the network layer, it can be said to be a different security system from the general idea of a firewall.

As has been described, the present invention provides a method for ensuring the security of computers connected to a network.

Those skilled in the art will appreciate that the mechanisms of the present invention are capable of being distributed as a computer program product in a variety of computer-readable storage medium such as compact discs, digital versatile discs, etc.

While the invention has been particularly shown and described with reference to a preferred embodiment, it will be understood by those skilled in the art that various changes in form and detail may be made therein without departing from the spirit and scope of the invention.

What is claimed is:

1. A method for allowing a first computer connected to a network to access a second computer connected to said network, said method comprising:
in response to the receipt of a plurality of authentication packets from a first computer by a second computer, wherein said plurality of authentication packets is transmitted from said first computer to said second computer using a plurality of transmission time slots corresponding to transmission timings based on a first set of authentication code generated by said first computer, measuring by said second computer a slot interval of a plurality of reception time slots corresponding to arrival timings of said respective authentication packets;
generating by said second computer a second set of authentication code that is identical to said first set of authentication code; and
permitting access of said first computer by said second computer based on said measured slot interval and said second authentication code.

2. The method of claim 1, wherein said first authentication code is generated from a bit string that includes first time information possessed by said first computer and a first password, and said second authentication code is generated from a bit string that includes second time information possessed by said second computer and synchronized with said first time information and a second password that is identical to said first password.

3. The method of claim 1, wherein said transmission time slots are formed of time slots assigned to pulse-position modulation codes generated by performing pulse-position modulation on said first set of authentication code.

4. The method of claim 1, wherein said transmission time slots are formed of time slots assigned to codes generated by breaking said bit string of said first set of authentication code into a predetermined number of bits.

5. The method of claim 1, wherein
said transmission of said plurality of authentication packets by said first computer is executed when an application program of said first computer starts accessing said second computer; and
said method further includes storing data packets created based on an access request of said application program in a buffer for a predetermined period by said first computer.

6. The method of claim 1, wherein said transmission of said plurality of authentication packets by said first computer includes transmitting a preamble packet before transmitting said plurality of authentication packets.

7. The method of claim 6, further comprising:
measuring a slot period of said preamble packet by said second computer; and
setting a slot period of said reception time slots based on said slot period of said preamble packet by said second computer.

8. The method of claim 1, further comprising generating a new authentication code by said first computer and transmitting a plurality of authentication packets to said second computer using time slots having a slot period longer than said slot period of said time slots which were used at said time of transmitting said plurality of previous authentication packets.

9. The method of claim 1, further comprising sending a notification to said first computer by said second computer to inform that access is permitted.

10. The method of claim 1, wherein said transmission of said plurality of authentication packets by said first computer further includes a transmission of a plurality of identifier packets using a transmission time slot generated from a user identifier of said first computer.

11. A computer-readable storage medium having a computer program product for allowing a first computer connected to a network to access a second computer connected to said network, said computer-readable storage medium comprising:
program code for, in response to the receipt of a plurality of authentication packets from a first computer by a second computer, wherein said plurality of authentication packets is transmitted from said first computer to said second computer using a plurality of transmission time slots corresponding to transmission timings based on a first set of authentication code generated by said first computer, measuring by said second computer a slot interval of a plurality of reception time slots corresponding to arrival timings of said respective authentication packets;
program code for generating by said second computer a second set of authentication code that is identical to said first set of authentication code; and
program code for permitting access of said first computer by said second computer based on said measured slot interval and said second authentication code.

12. The computer-readable storage medium of claim 11, wherein said first authentication code is generated from a bit string that includes first time information possessed by said first computer and a first password, and said second authentication code is generated from a bit string that includes second time information possessed by said second computer and synchronized with said first time information and a second password that is identical to said first password.

13. The computer-readable storage medium of claim 11, wherein said transmission time slots are formed of time slots assigned to pulse-position modulation codes generated by performing pulse-position modulation on said first set of authentication code.

14. The computer-readable storage medium of claim 11, wherein said transmission time slots are formed of time slots assigned to codes generated by breaking said bit string of said first set of authentication code into a predetermined number of bits.

15. The computer-readable storage medium of claim 11, wherein
said transmission of said plurality of authentication packets by said first computer is executed when an application program of said first computer starts accessing said second computer; and
said computer-readable storage medium further includes program code for storing data packets created based on an access request of said application program in a buffer for a predetermined period by said first computer.

16. The computer-readable storage medium of claim 11, wherein said transmission of said plurality of authentication packets by said first computer includes a transmission of a preamble packet before transmitting said plurality of authentication packets.

17. The computer-readable storage medium of claim 6, further comprising:
program code for measuring a slot period of said preamble packet by said second computer; and
program code for setting a slot period of said reception time slots based on said slot period of said preamble packet by said second computer.

18. The computer-readable storage medium of claim 11, further comprising program code for generating a new authentication code by said first computer and transmitting a plurality of authentication packets to said second computer using time slots having a slot period longer than said slot period of said time slots which were used at said time of transmitting said plurality of previous authentication packets.

19. The computer-readable storage medium of claim 11, further comprising program code for sending a notification to said first computer by said second computer to inform that access is permitted.

20. The computer-readable storage medium of claim 11, wherein said transmission of said plurality of authentication packets by said first computer further includes a transmission of a plurality of identifier packets using a transmission time slot generated from a user identifier of said first computer.
